(19) United States
(12) Patent Application Publication
(10) Pub. No.: US 2004/0251218 A1
(43) Pub. Date: Dec. 16, 2004

(54) Desludging device and method for desludging a liquid

(76) Inventors: Paolo Giordani, Crema (IT); Fabio Musiani, Lombarda/Italy (IT); Vittorio Degara, Melegnano/Italy (IT); Dario Negri, Bagnolo Cremasco/Italy (IT)

Correspondence Address: ALBERT JOHN HOFELDT, 314 WEST SAN MARINO DRIVE, MIAMI BEACH, FL, 33139, US

(21) Appl. No.: 10/480,055

(22) PCT Filed: May 31, 2002
(86) PCT No.: PCT/EP02/05965

(30) Foreign Application Priority Data
Jun. 9, 2001 (DE) 101 28 062.9

(51) Int. Cl. B01D 21/00

(52) U.S. Cl. 210/800; 210/513

(57) ABSTRACT

Desludging device for a portion of the total volume of a liquid that contains suspended solids and/or can form sludge, arranged in a tank for the total volume of the liquid in such a way that at least a part of said desludging device including its floor is immersed in the total volume, wherein said desludging device has an inlet opening located above said floor through which a portion of the liquid can enter the desludging device, as well as a discharge device beginning above said floor, in the form of an exit pipe, a channel, an overflow weir or at least an opening in the wall, through which the liquid can be removed from the desludging device, and wherein said floor of the desludging device has at least one outlet opening through which sludge that has settled in said desludging device can be returned to the total volume of the liquid or passed to another settling device for concentrating the sludge. Preferably the settled sludge is recycled to the total volume through a Venturi-type nozzle. The desludging device is particularly suitable for use in a process for taking automatically desludged bath samples for analysis purposes.

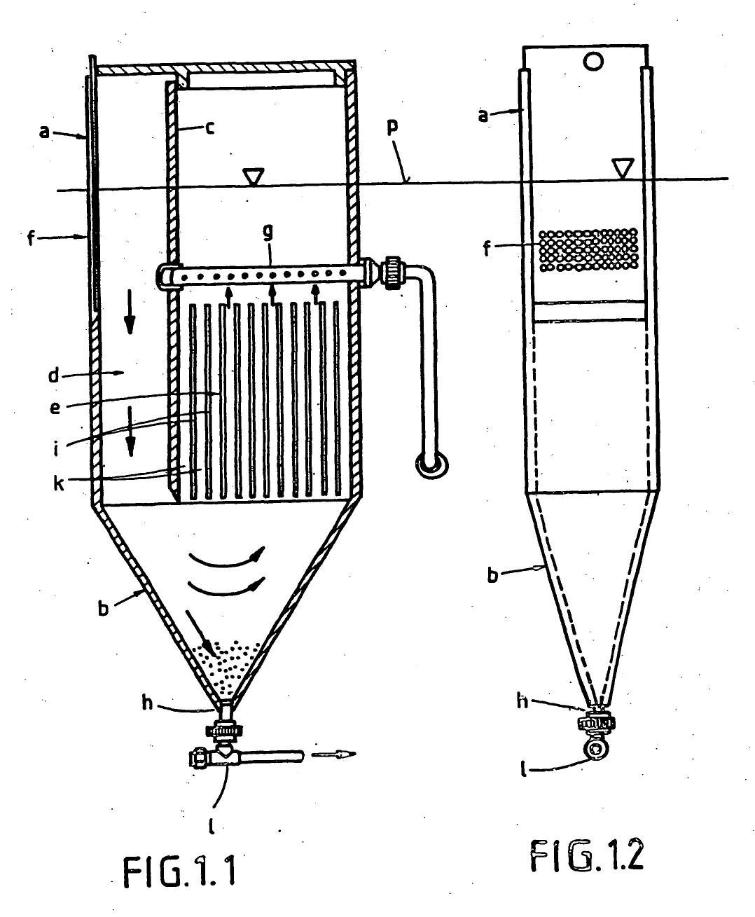

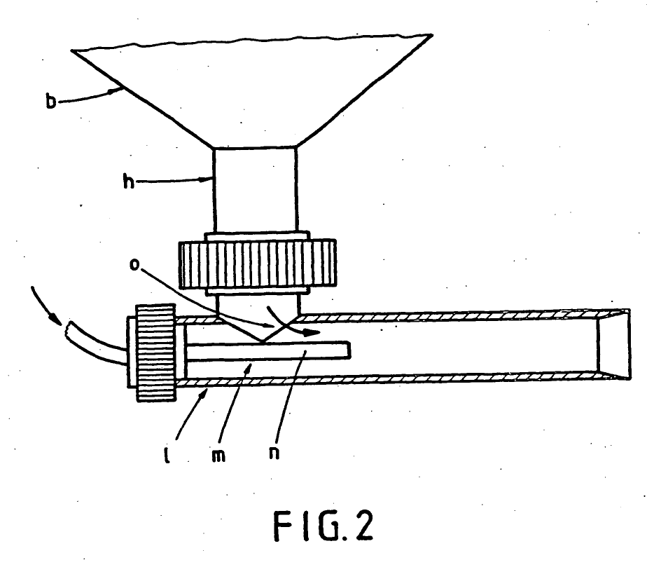

The present invention relates to a new process for the desludging of a liquid and a desludging device suitable for this purpose. The device and process are suitable for desludging a large number of various liquids, in particular water, that contain sedimenting solids as a sludge or in which such solids are formed on account of a chemical reaction. Examples of such liquids are effluent that already contains sludge or in which sludge is formed as a result of a precipitation reaction, a metal treatment fluid, a cleaning fluid, a pickling solution for pickling metal surfaces, or a conversion solution for a conversion treatment of metal surfaces.

The desludging of liquids is a task that frequently occurs in various fields in technology. In principle two processes are used for this purpose:

1. The liquid volume to be desludged is contained in a settling tank or is passed through such a tank. The liquid in the settling tank is largely at rest or possibly executing a slow flow movement, so that sludge can collect on the floor of the settling tank. The floor of the tank is as a rule either inclined towards one side or tapers towards a point, whereby the sludge collects at the lowest lying point and can be discharged therefrom to the outside.

2. A part of the liquid to be desludged is continuously or discontinuously extracted from the total volume and is either passed into a settling tank as described above or desludged by mechanical aids. Such mechanical aids may for example comprise a filtration device or a centrifuge (separator).

A common feature of both procedures is that the sludge is extracted and disposed of together with a part of the liquid from the total volume of the liquid to be desludged. The object of the present invention on the other hand is to provide a device and a process in which a (minor) partial volume is to be removed in as solids-free form as possible from a total volume of a liquid containing a sludge. For this purpose it is necessary to separate as large a proportion of the sludge as possible from the portion of the liquid to be removed. This sludge to be separated represents only a minor portion of the total sludge present in the overall volume of the liquid, with the result that as a rule it is not profitable to separate this (minor) portion of sludge from the remainder of the sludge in the total volume of the liquid and to dispose of it separately.

A first aspect of the present invention relates to a desludging device (a), (b) for a portion of a total volume of a liquid that contains the suspended solid or may form sludge, arranged in a tank for the total volume of the liquid, so that at least a part of said desludging device including its floor is immersed in the total volume, the desludging device having an inlet opening (f) above said floor, through which a portion of the liquid can enter said desludging device, as well as a discharge device (g) beginning above said floor, in the form of an exit pipe, a channel, an overflow weir or at least an opening in the wall, through which the liquid can be removed from said desludging device, wherein said floor of the desludging device has at least one outlet opening (h) through which the sludge that has settled in the desludging device can be returned to the total volume of the liquid or passed to another settling device for concentrating the sludge.

Accordingly, in contrast to desludging devices of the prior art, one embodiment of the desludging device according to the invention is characterized by the fact that it is at least partially immersed, and at least its lower end (floor) is immersed, in the total volume of the liquid of which only a portion is to be desludged. The sludge settling in the desludging device is continuously or discontinuously returned to the total volume of the liquid through one or more outlet openings in the floor of said desludging device. This can be effected under gravity or by mechanical aids, for example by a pump. This desludging device may have any suitable shape as long as it satisfies the objective that the liquid contained therein also flows only so slowly that the sludge sinks to the bottom and collects on the floor of the desludging device. In this connection it is preferred if the floor inclines downwardly in the direction of the one or more outlet openings or tapers downwardly. The horizontal cross-section of the desludging device may be of any arbitrary shape, and may for example be circular, elliptical, rectangular or square. For reasons of optimal space utilization a rectangular or square horizontal cross-section is preferred.

In a preferred embodiment the desludging device is designed so that it has an upper part (a) and a lower part (b), wherein the walls of the upper part are substantially vertical and the walls of the lower part are inclined in such a way that the cross-section of the lower part tapers downwardly, the upper part being subdivided by a separating wall (c) into an inflow part (d) and an outflow part (e) for the liquid, the inlet opening (f) for the liquid being provided in the inflow part, wherein the liquid in the inflow part moves downwardly and in the outflow part moves upwardly and wherein in the outflow part the discharge device (g) begins, through which the liquid can be removed from the outflow part, wherein at the lowest lying and narrowest point of the lower part an outlet opening (h) is arranged through which the sludge that has settled in the desludging device can be returned to the total volume of the liquid.

In this embodiment the desludging device thus comprises an upper part with substantially vertical walls and a lower part that tapers downwardly in the direction of the outlet opening. The upper part is subdivided by a separating wall into an inflow part and an outflow part, the volume of the inflow part preferably being less than the volume of the outflow part. Liquid can enter the inflow part through an inlet opening that may be formed either by the upper boundary of the inflow part or by an opening in the side wall. When desludged liquid is removed from the outflow part through the discharge device, liquid flows from the inflow part into the outflow part. Since the inflow part and outflow part are separated from one another at the top by the separating wall, the liquid flows around the lower end of the separating wall from the inflow part into the outflow part. Accordingly, the liquid in the inflow part moves downwardly and in the outflow part moves upwardly. If the volume of the outflow part is larger than that of the inflow part, the flow velocity in the outflow part is less than in the inflow part. The sludge in the outflow part can thus settle on the bottom and collect in the lower, downwardly tapering part of the desludging device, from where it can be returned continuously or discontinuously, through the outlet opening, to the total volume of the liquid.

A special embodiment of the invention relates to a desludging device for desludging a liquid, comprising an upper part (a) and a lower part (b), wherein the walls of the upper part are substantially vertical and the walls of the lower part are inclined in such a way that the cross-section of the lower part tapers downwardly, wherein the upper part is subdivided by a separating wall (c) into an inflow part (d) and an outflow part (e) for the liquid, an inlet opening (f) for the liquid being provided in the inflow part, wherein the liquid in the inflow part moves downwardly and in the outflow part moves upwardly and wherein the outflow part is subdivided by one or more guideplates (i) into two or more segments (k), and a discharge device (g) in the form of an exit pipe, a channel, an overflow weir or at least an opening in the wall begins above the said guideplates, through which the liquid can be removed from the outflow part, wherein at the lowest lying and narrowest point of the lower part an outlet opening (h) is provided that terminates in the outer pipe (m) of a discharge nozzle (1) lying thereunder, the said nozzle containing an outer pipe (m) and an inner pipe (n), wherein the inner pipe runs substantially parallel to the outer pipe and wherein a substance stream can be fed into the inner pipe from outside the desludging device and wherein the inner pipe, looking in the direction of this substance stream, ends within the outer pipe at a point between that point (o) at which the outlet opening (h) terminates in the outer pipe (m), and the end of the said outer pipe, wherein the substance stream in the inner pipe aspirates on account of its suction effect a partial stream of the liquid in the desludging device together with the sludge and discharges it into the medium surrounding the desludging device.

According to this embodiment the outflow part is subdivided by one or more guideplates into two or more segments, the beginning of the discharge device lying above these guideplates. The guideplates ensure a largely laminar upward flow of the liquid in the outlet part and thereby promote the settling of the sludge. It is furthermore envisaged according to this embodiment that the outlet opening in the lower part of the desludging device, optionally with the aid of a connecting pipe, leads to a discharge nozzle through which the sludge that has collected in the desludging device can be returned to the total volume of the liquid. This discharge nozzle contains an outer pipe and an inner pipe that run substantially parallel to one another. Preferably the outer pipe at that end at which the inner pipe enters the outer pipe is closed to the total volume of the liquid. At the outlet side for the sludge the outer pipe is extended beyond the inner pipe, i.e. the inner pipe terminates within the outer pipe. The end of the inner pipe thus lies at a point between that point at which the outlet opening terminates in the outer pipe, and the end of the outer pipe. If a substance stream is now fed from outside the desludging device into the inner pipe, this substance stream passes at the end of the inner pipe into the outer pipe and there effects a flow from the outer pipe onwards into the total volume of the liquid. A suction effect is thereby created in the outer pipe by means of which sludge and liquid are sucked through the outlet opening of the desludging device into the outer pipe and are finally discharged into the total volume of the liquid. The resultant effect is one that is also utilized in a Venturi nozzle. The discharge nozzle thus operates according to the Venturi principle, so that it could also be described as a “Venturi-like” nozzle.

Irrespective of the particular embodiment, the desludging device is preferably made of a material that is attacked as little as possible by the liquid to be desludged. Preferred materials are plastics or stainless steel, preferably high-alloy stainless steel.

If the desludging device is provided as described above with a “Venturi-like” discharge nozzle, it is not necessary for the nozzle to be immersed in the total volume of the liquid. However, this is obviously one possible embodiment, in which the desludging device is mounted in the tank for the total volume of the liquid. The desludging device may however also be mounted outside the tank for the total volume of the liquid in such a way that a part of the liquid can enter the inflow part of the desludging device through the inlet opening, and that the outer pipe of the discharge nozzle ends within the total volume of the liquid. In this case too the effect according to the invention is achieved, whereby a desludged portion of the total volume of the liquid can be removed and the sludge separated from this portion is returned to the total volume of the liquid. For reasons of space it is however generally preferred if the desludging device is accommodated within the tank for the total volume of the liquid.

Irrespective of the embodiment of the desludging device the inlet opening may constitute the upper end of the desludging device as long as the said upper end lies below the liquid level in the tank for the total volume of the liquid. A better functional capacity is however ensured if the upper end of the desludging device projects from the total volume of the liquid to be desludged and a portion of this liquid can enter the desludging device through an inlet opening on one side of the said device. So far as the desludging device is subdivided into an inflow part and an outflow part, the inlet opening is located in the inflow part. In this connection the inlet opening may be designed as a simple opening of sufficiently large cross-section. In order to prevent coarse solids entering the desludging device, it is however preferred to form the inlet opening either as a sieve plate, i.e. consisting of a plurality of relatively small openings, or to close the inlet opening with a net. It is furthermore preferred that a part of the side wall of the desludging device that contains the inlet opening designed as a sieve plate or provided with a sieve, can readily be removed from the rest of the desludging device for cleaning purposes and can be reused.

If the inlet opening in the desludging device lies below the liquid level of the total volume of the liquid, this has the additional advantage that specifically lighter substances than the main component of the liquid to be desludged can move upwardly within the desludging device, especially in an existing inflow part, and thereby do not reach the outflow part, where on account of their upward flow movement they could interfere in the settling of the sludge. Such specifically lighter substances may for example be oils if the liquid to be desludged is an oil-in-water emulsion. This may be the case for example if the liquid to be desludged is a cleaning fluid, a metal treatment fluid, or effluent. The upwardly separating constituents may however also include air bubbles if air is fed into the total volume of the liquid. This is often the case for example in pickling baths used to pickle surfaces, in which air is introduced to achieve a better mixing and possibly also to oxidize oxidizable components.

Irrespective of the embodiment of the desludging device the initial part of the discharge device may consist of an open pipe. In order to achieve a more uniform flow of the liquid, it is however preferred if the initial part of the discharge device consists of a pipe piece that contains several openings through which the liquid can enter the said pipe piece. This embodiment is particularly preferred if the desludging device contains an outflow part separated by a separating wall from the inflow part. In this case the pipe piece provided with holes preferably extends over the whole distance between the separating wall at the inflow part and the opposite wall of the desludging device. As long as the outflow part is subdivided by guideplates into segments, the initial section of the discharge device preferably contains just as many holes at the inlet for the liquid, as the outflow part has segments. In each case a hole is preferably arranged over a segment. Obviously instead of just one pipe piece several adjacently lying pipe pieces may also be provided, that terminate in a common discharge device. Furthermore, the initial part of the discharge device could be shaped like a box, one surface of the box, preferably the lower surface, having a plurality of holes to permit the inflow of liquid into the box-shaped initial part of the discharge device. The liquid is preferably conveyed in the discharge device by means of a pump.

It is generally preferred if, for reasons of space, the desludging device has a rectangular or square horizontal cross-section and if the lower part, where present, has the shape of an inverted rectangular or square pyramid. In this case, for reasons of space and efficiency, it is preferred that the overall height of the desludging device is greater than the longest side of the horizontal cross-section.

The efficiency of the sludge separation is promoted if the outflow part is subdivided into segments by parallel guideplates. Preferably one to 30 guideplates, in particular 5 to 15 guideplates are envisaged, preferably running parallel to one another. It is particularly favorable for the settling of the sludge if the height of the guideplates is 5 to 30 times, in particular 10 to 20 times, the spacing between the guideplates.

For reasons of space and efficiency of the sludge separation, it is preferred that the desludging device has a rectangular horizontal cross-section and that the long side of the rectangle is 1.5 to 5 times as long, in particular 1.5 to 3 times as long, for example roughly twice as long as the short side. In this connection it is again particularly favorable for the sludge separation if the separating wall between the inflow part and outflow part and, where present, the guideplates in the outflow part, are arranged substantially parallel to the short side of the rectangle.

Irrespective of the cross-section of the desludging device, the guideplates are preferably arranged so that they are inclined at an angle of between 0° and 30° to the vertical. An inclination to the vertical, i.e. an inclined arrangement, is in principle more favorable for the separation of the sludge than a predominantly vertical arrangement. However, in the case of an inclined arrangement there is an increased danger that sludge particles will settle on the lower side of the inclined guideplate and will be entrained by the liquid flowing upwardly along the lower side. This danger is reduced if the guideplates are arranged substantially vertically. For this reason it is preferred within the scope of the present invention to arrange the guideplates substantially vertically.

The spacing between the guideplates is preferably between 10 and 100 mm, in particular between 20 and 60 mm.

A second aspect of the present invention relates to a process for the desludging of a portion of the total volume of a liquid, wherein a desludging device as described above is employed. Compared to the prior art this process differs in that the settling sludge is not separated and disposed of, but is returned to the total volume of the liquid. This sludge can then be disposed of together with the remaining sludge separating in the total volume of the liquid.

In this connection a process is preferred in which a desludging device according to one or more of claims 3 to 10 is employed, wherein the desludging device is immersed in the total volume of the liquid so that liquid can enter the inflow part through the inlet opening, and a first portion of the entering liquid is removed through the discharge device and a second portion is recycled through the discharge nozzle to the total volume of the liquid on account of the suction effect of the substance stream fed from outside the desludging device into the inner pipe of the discharge nozzle. This second portion entrains the settled sludge. A desludging device is accordingly preferably used that is subdivided into an inflow part and an outflow part, the said outflow part being subdivided into segments by guideplates. Furthermore, a “Venturi-like” discharge nozzle is preferably envisaged for the recycling of the settled sludge to the total volume of the liquid.

The composition of the substance stream that is fed into the inner pipe of the discharge nozzle preferably depends on the nature of the liquid to be desludged and the technical process that takes place in the total volume of the liquid. In the simplest case this substance stream consists of the same liquid as the liquid to be desludged. For the total volume of the liquid this has the effect that a partial stream of the liquid is circulated by pumping. This is the case in many technical processes, where a better mixing of the total volume is achieved by the circulation pumping. In addition the circulation pumping can be used to alter the temperature of the pumped liquid, for example to cool or heat the liquid. If on account of the technical processes occurring in the total volume of the liquid this total volume has to be increased, for example with water or with an aqueous solution of active substances, then the substance stream fed into the inner pipe of the discharge nozzle may consist of water or an aqueous solution of active substances. If the total volume of the liquid is to be gassed, for example aerated, then the air stream fed into the inner pipe of the discharge nozzle may consist of this gas, in particular air. Accordingly, the substance stream fed into the inner pipe of the discharge nozzle is preferably chosen so that it produces a technical effect within the total volume of the liquid. This has the economic benefit that no additional energy has to be expended in recycling sludge and a portion of the liquid from the desludging device to the total volume of the liquid. Instead a substance stream is used for this purpose that would also be fed into the total volume of the liquid without using a desludging device according to the invention. If the process according to the invention is used for example for desludging part of a pickling solution that is mixed and possibly oxidized by blowing in air, it is preferred if the substance stream fed into the inner pipe of the discharge nozzle consists of air. In this connection it is sufficient if the air that is fed in is at a pressure that is just above the hydrostatic pressure in the total volume of the liquid at the height of the air inlet.

If a desludging device is used with an inflow part and an outflow part, the flow velocity of the upwardly flowing liquid in the outflow part is regulated so that a settling of the sludge is ensured. In this connection the optimal flow velocity depends on the specific weight of the sludge, the geometrical shape of the sludge particles, and the viscosity of the liquid. If the liquid is water, the amounts of liquid entering the desludging device through the inlet opening and leaving the desludging device through the discharge device and the discharge nozzle are preferably adjusted so that the liquid in the outflow part moves upwardly at a velocity of between 0.3 and 6 mm/sec. With a compact and specifically dense sludge a flow velocity can be adjusted in the upper half of this range, while with a specifically lighter and flocculent sludge a flow velocity can be adjusted in the lower half of this range. For many cases occurring in practice it is preferred if the liquid in the outflow part moves upwardly at a velocity of between 0.6 and 3 mm/sec. If the liquid to be desludged is for example a pickling solution used to pickle metal surfaces, in particular stainless steel surfaces, and the settling sludge is a pickling sludge, then the liquid stream is preferably adjusted so that the liquid in the outflow part moves upwardly at a velocity of between 0.8 and 1.5 mm/sec.

Obviously this adjustment presupposes that the vertical cross-section of the desludging device and in particular the vertical cross-section of the outflow part is chosen so that, by adjusting the aforementioned flow velocities, the desired portion of liquid can be removed through the discharge device of the desludging device. If for example the volume of the liquid to be removed through the discharge device is in the region of about 100 ml/sec., it can be calculated what cross-section the outflow part of the desludging device must have in order to maintain the desired movement velocity of the liquid in the outflow part.

The total volume of the desludging device and the amounts of liquid entering the desludging device and leaving the latter through the discharge device and the discharge nozzle are preferably chosen so that the liquid contained within the desludging device is replaced 1 to 5 times per hour, preferably 2 to 4 times per hour. For example these quantities can be regulated so that the liquid within the desludging device is completely replaced about every 15 to 30 minutes. These values are optimized for the particular application where the liquid to be desludged is a pickling liquid for stainless steel and where a sludge-free representative sample is to be removed through the discharge device for analysis purposes.

The liquid to be desludged may be of widely varying types. For example the liquid may be an effluent that either already contains sludge or in which sludge is formed as a result of chemical processes. Such a chemical process may for example be a precipitation or neutralization reaction that is employed in the treatment of the effluent. Moreover the liquid may be a metal treatment liquid, such as for example a coolant for metal cutting work or a roller oil emulsion. Sludge is formed in this case by metal abrasion on the workpiece. The liquid may furthermore be a cleaning liquid in which sludge-forming solids are introduced through the material to be cleaned. The liquid may moreover be a pickling solution for pickling metal surfaces. Finally, the liquid may also be a conversion solution for a conversion treatment of metal surfaces, i.e. a chemical transformation of the metal surface. A particular example of this is a phosphating solution for the layer-forming or non layer-forming phosphating of metal surfaces, in particular a zinc phosphating solution. Such phosphating solutions tend to form sludge containing metal phosphates.

The desludged portion of the liquid that may be removed through the outflow part and the discharge device of the desludging device, may be used for various purposes. In particular this part of the liquid may be used to determine the composition of the liquid by analytical measurements. In this connection it is particularly envisaged in accordance with the invention that the portion of the liquid that is removed through the outflow part and the discharge device of the desludging device is passed to analytical equipment that automatically determines one or more characteristics of the composition of the liquid. The desludging device according to the invention may thus be used within the framework of an automated analytical monitoring of various process baths, as is known in the prior art. An automatic monitoring and regulation of cleaning baths is described for example in the documents DE 198 02 725, DE 198 14 500 and DE 198 20 800. If the process according to the invention is to be used to monitor a pickling solution, a measurement process as described in WO 00/33061 may for example be connected upstream. This process has been developed in particular for monitoring and controlling nitric acid-free pickling fluids for stainless steel. Such pickling solutions are described in more detail for example in documents EP-A-505 606 and EP-A-582 121.

A preferred use of the process according to the invention is accordingly to provide desludged bath samples for known or new automated processes for monitoring and controlling the composition of technical baths. In this connection the desludging process preferably operates automatically so that human intervention is not required for the preparation of a desludged bath sample.

A secondary effect of the process according to the invention is that when using a discharge nozzle, eddy flows are generated in the total volume of the liquid that ensure that sludge settling in the total volume of the liquid accumulates at selected points on the floor of the tank for the total volume of the liquid. This sludge may then preferably be removed at these points from the total volume of the liquid, for example by suctioning. In this way the desludging of the total volume of the liquid can be performed more economically, since it is possible to remove the sludge specifically at those points where it preferentially accumulates as a result of the execution of the process according to the invention. An additional benefit of the process according to the invention and thus a further aspect of the present invention is that in the desludging process according to the invention a desludging device with a discharge nozzle corresponding to one or more of claims 3 to 10 is employed, and that the said discharge nozzle is aligned in the total volume of the liquid so that sludge settling in the total volume of the liquid accumulates on account of the eddy flow formation in specific regions of the total volume, from where it can be removed and separated by an external further desludging device.

### Reference List

(a) Upper part of the desludging device

(b) Lower part of the desludging device

(c) Separating wall between the inflow part (d) and outflow part (e)

(d) Inflow part

(e) Outflow part

(f) Inlet opening (formed as a sieve plate)

(g) Discharge device in the form of an exit pipe

(h) Outlet opening for sludge

(i) Guideplates

(k) Segments in the outflow part

(l) Discharge nozzle

(m) Outer pipe of the discharge nozzle

(n) Inner pipe of the discharge nozzle

(o) Termination of the outlet opening (h) in the outer pipe (m)

(p) Liquid surface

### Diagram Captions

1 Vertical section through a desludging device with a rectangular horizontal cross-section parallel to the long side of the rectangle

2 Vertical section through a desludging device with a rectangular horizontal cross-section parallel to the short side of the rectangle

2 Section through the discharge nozzle

1. Desludging device for a portion of the total volume of a liquid that contains suspended solids and/or can form sludge, arranged in a tank for the total volume of the liquid in such a way that at least a part of said desludging device including its floor is immersed in the total volume, wherein said desludging device has an inlet opening located above said floor through which a portion of the liquid can enter the desludging device, as well as a discharge device beginning above said floor, in the form of an exit pipe, a channel, an overflow weir or at least an opening in the wall, through which the liquid can be removed from the desludging device, and wherein said floor of the desludging device has at least one outlet opening through which sludge that has settled in said desludging device can be returned to the total volume of the liquid or passed to another settling device for concentrating the sludge.

2. Desludging device according to claim 1, characterized in that it has an upper part and a lower part, wherein the walls of the upper part are substantially vertical and the walls of the lower part are inclined in such a way that the cross-section of the lower part tapers downwardly, wherein the upper part is subdivided by a separating wall into an inflow part and an outflow part for the liquid, the inlet opening for the liquid being provided in said inflow part, wherein the liquid in the inflow part moves downwardly and in the outflow part moves upwardly and wherein in the outflow part the discharge device begins, through which the liquid can be removed from the said outflow part, and wherein an outlet opening is provided at the lowest lying and narrowest point of said lower part, through which sludge that has settled in the desludging device can be returned to the total volume of the liquid.

3. Desludging device for desludging a liquid, comprising an upper part and a lower part, wherein the walls of said upper part are substantially vertical and the walls of said lower part are inclined so that the cross-section of said lower part tapers downwardly, wherein said upper part is subdivided by a separating wall into an inflow part and an outflow part for the said liquid, an inlet opening for the said liquid being provided in said inflow part, wherein the liquid in the inflow part flows downwardly and in said outflow part flows upwardly and wherein the outflow part is subdivided by one or more guideplates into two or more segments and above the said guideplates begins a discharge device in the form of an exit pipe, a channel, an overflow weir or at least an opening in the wall, through which the said liquid can be removed from said outflow part, wherein an outlet opening is provided at the lowest lying and narrowest point of said lower part, which terminates in the outer pipe of a discharge nozzle lying thereunder that contains an outer pipe and an inner pipe, wherein said inner pipe runs substantially parallel to said outer pipe and wherein a substance stream can be fed into said inner pipe from outside the desludging device and wherein said inner pipe, looking in the direction of this substance stream, ends within the outer pipe at a point between that point at which the outlet opening terminates in the outer pipe, and the end of the said outer pipe, wherein the substance stream in the inner pipe on account of its suction effect aspirates a partial stream of the said liquid in said desludging device together with the sludge and discharges the said liquid and sludge into the medium surrounding said desludging device.

4. Desludging device according to claim 3, characterized in that it is mounted in or on a tank for the total volume of the liquid in such a way that a part of the liquid can enter said inflow part of the desludging device through said inlet opening, and that said outer pipe of the discharge nozzle ends within the total volume of the liquid.

5. Desludging device according to one or more of claims 1 to 4, characterized in that it has a rectangular or square horizontal cross-section and that the lower part has the shape of an inverted rectangular or square pyramid.

6. Desludging device according to one or more of claims 2 to 5, characterized in that said outflow part is subdivided into segments by 1 to 30 parallel guideplates, the height of said guideplates being 5 to 30 times the spacing between said guideplates.

7. Desludging device according to one or more of claims 1 to 6, characterized in that it has a rectangular horizontal cross-section and that the long side of the rectangle is 1.5 to 5 times as long as the short side.

8. Desludging device according to one or more of claims 2 to 7, characterized in that said separating wall between the inflow part and outflow part and, where present, said guideplates in the outflow part, are arranged substantially parallel to the short side of the rectangle.

9. Desludging device according to one or more of claims 6 to 8, characterized in that said guideplates are arranged at an angle of between 0° and 300 to the vertical.

10. Desludging device according to one or more of claims 6 to 9, characterized in that the spacing between said guideplates is 10 to 100 mm.

11. Process for the desludging of a portion of a total volume of a liquid using a desludging device according to one or more of claims 1 to 10.

12. Process for the desludging of a portion of a total volume of a liquid using a desludging device according to one or more of claims 3 to 10, wherein said desludging device is immersed in the total volume of the liquid so that liquid can enter the inflow part through the inlet opening, and a first portion of the entering liquid is removed through the discharge device and a second portion is returned to the total volume of the liquid through said discharge nozzle as a result of the suction effect of the substance stream fed into the inner pipe of said discharge nozzle from outside the desludging device.

13. Process according to claim 12, characterized in that the substance stream fed into said inner pipe of said discharge nozzle from outside said desludging device consists of the same liquid as the liquid to be desludged, or consists of water or a gas, in particular air.

14. Process according to one or both of claims 12 and 13, characterized in that the amounts of liquid entering said desludging device through the inlet opening and leaving said desludging device through said discharge device and said discharge nozzle are adjusted so that the liquid in the outflow part moves upwardly at a velocity of between 0.3 and 6 mm/sec.

15. Process according to claim 14, characterized in that the liquid in the outflow part moves upwardly at a velocity of between 0.6 and 3 mm/sec.

16. Process according to one or both of claims 14 and 15, characterized in that the amounts of liquid entering said desludging device and leaving said desludging device through the discharge device and the discharge nozzle are adjusted so that the liquid contained within the desludging device is replaced 1 to 5 times per hour.

17. Process according to one or more of claims 11 to 16, characterized in that said liquid to be desludged is an effluent, a metal treatment fluid, a cleaning fluid, a pickling solution for the pickling of metal surfaces, or a conversion solution for a conversion treatment of metal surfaces, in particular a phosphating solution for phosphating metal surfaces.

18. Process according to one or more of claims 11 to 17, characterized in that the portion of the liquid removed through said outflow part and said discharge device of said desludging device is passed to analysis equipment that automatically determines one or more characteristics of the composition of the liquid.

19. Process according to one or more of claims 11 to 18, characterized in that a desludging device according to one or more of claims 3 to 11 is used and that said discharge nozzle is aligned in the total volume of the liquid in such a way that sludge settling in the total volume of the liquid accumulates on account of the eddy flow formation in specific regions of the total volume, from where it can be removed and separated by an external further desludging device.
